(19) United States
(12) Patent Application Publication
(10) Pub. No.: US 2007/0058846 A1
(43) Pub. Date: Mar. 15, 2007

(54) Three-dimensional image processing apparatus, three-dimensional image processing method and control program used in three-dimensional image processing apparatus

(76) Inventor: Satoru Ohishi, Otawara-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/430,912

(22) Filed: May 10, 2006

(30) Foreign Application Priority Data
May 10, 2005 (JP) 2005-137381

(51) Int. Cl. G06K 9/00

(52) U.S. Cl. 382/128

(57) ABSTRACT

A 3D-image processing apparatus comprising a first acquisition device, a second acquisition device, and a computing unit. The first acquisition device acquires displacement information about first 3D-imaging data and second 3D-imaging data different from the first 3D-imaging data. The first 3D-imaging data represents one of three-dimensional images different in diagnostic mode regarding a subject. The second acquisition device acquires displacement information about the second 3D-imaging data and a third 3D-imaging data different from the first and second 3D-imaging data. The computing unit obtains displacement information about the first 3D-imaging data and the third 3D-imaging data, from the displacement information acquired by the first and second acquisition devices.

### CROSS-REFERENCE TO RELATED APPLICATIONS

This application is based upon and claims the benefit of priority from prior Japanese Patent Application No. 2005-137381, filed May 10, 2005, the entire contents of which are incorporated herein by reference.

### BACKGROUND OF THE INVENTION

1. Field of the Invention

The present invention relates to a 3D (three-dimensional)-image processing apparatus and a 3D-image processing method, which process and display various 3D-image data obtained by diagnosing a subject. The invention relates to a control program for use in the 3D-image processing apparatus.

2. Description of the Related Art

A technology is known, in which a subject is diagnosed at high accuracy by synthesizing images of the subject, which have been prepared by using various diagnostic systems. As known in the art, this technology is used in surgical operations. Particularly, it is used when a 3D image of the structure of the bones, internal organs and the like, obtained by computed tomography (CT), is synthesized with a 3D image representing the functional of the bones, internal organs and the like, obtained by magnetic resonance imaging (MRI). Before the two 3D are synthesized, they are associated or the markers attached them are associated, thereby correcting the displacement of the 3D images. Thus, desirable synthesized information is acquired (see, for example, Jpn. Pat. Appln. KOKAI Publication No. 5-137711).

However, many manual operations are required to associate the two images obtained by CT and MRI or to attach markers to these images. The operator's workload is inevitably heavy. This is because the subject is scanned from various directions in the process of providing the 3D images. Ultimately, it is difficult to achieve an accurate diagnosis in a short time.

### BRIEF SUMMARY OF THE INVENTION

Accordingly, an object of the present invention is to provide a 3D-image processing apparatus and a 3D-image processing method, which can reduce an operator's workload in synthesizing 3D images and which enables the doctors to make accurate diagnosis within a short time, and to provide a control program for use in the 3D-image processing apparatus.

A 3D-image processing apparatus according to this invention comprises: a first acquisition device which acquires displacement information about first 3D-imaging data and second 3D-imaging data different from the first 3D-imaging data, the first 3D-imaging data representing one of three-dimensional images different in diagnostic mode regarding a subject; a second acquisition device which acquires displacement information about the second 3D-imaging data and a third 3D-imaging data different from the first and second 3D-imaging data; and a computing unit which obtains displacement information about the first 3D-imaging data and the third 3D-imaging data, from the displacement information acquired by the first and second acquisition devices.

A 3D-image processing method according to this invention comprises: acquiring first displacement information representing displacement between first 3D-imaging data and second 3D-imaging data different from this first 3D-imaging data, the first 3D-imaging data representing one of 3D images different in a diagnostic mode regarding a subject; acquiring second displacement information representing displacement between the second 3D-image data and third 3D-imaging data different from the first and second 3D-imaging data; and obtaining third displacement information representing displacement between the first 3D-imaging data and the third 3D-imaging data, from the first displacement information and the second displacement information.

A control program according to this invention is to be recorded in a memory provided in a three-dimensional image processing apparatus and is designed to perform an image processing of three-dimensional image data. The program comprises: a first step of acquiring first displacement information representing displacement between first three-dimensional image data and second three-dimensional image data different from this first three-dimensional image data, the first three-dimensional image data representing one of three-dimensional images different in a diagnostic mode regarding a subject; a second step of acquiring second displacement information about the second three-dimensional image data and third three-dimensional image data different from the first and second three-dimensional image data; and a third step of obtaining displacement information about the first three-dimensional image data and the third three-dimensional image data from on the first displacement information and the second displacement information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a 3D-image processing apparatus that is a first embodiment of the present invention;

FIG. 2 is a diagram explaining how various images are processed to synthesize CT image data with MRI image data in the first embodiment;

FIG. 3 is a flowchart explaining a procedure of controlling the 3D-image processing apparatus, i.e., the first embodiment, to synthesize the CT image data with the MRI image;

FIG. 4 is a diagram depicting a synthesized image obtained in the first embodiment;

FIG. 5 is a block diagram showing a 3D-image processing apparatus that is a second embodiment of the present invention;

FIG. 6 is a block diagram showing a 3D-image processing apparatus that is a fourth embodiment of the present invention;

FIG. 7 is a block diagram showing a 3D-image processing apparatus that is a fifth embodiment of the present invention;

FIG. 8 is a diagram explaining how various images are processed to synthesize PET-CT image data with perfusion MRI image data in the sixth embodiment; and

FIG. 9 is a diagram explaining how various images are processed to synthesize PET-CT image data with perfusion MRI image data in a seventh embodiment of the present invention.

### DETAILED DESCRIPTION OF THE INVENTION

Embodiments of the present invention will be described below in detail with reference to the accompanying drawings.

(First Embodiment)

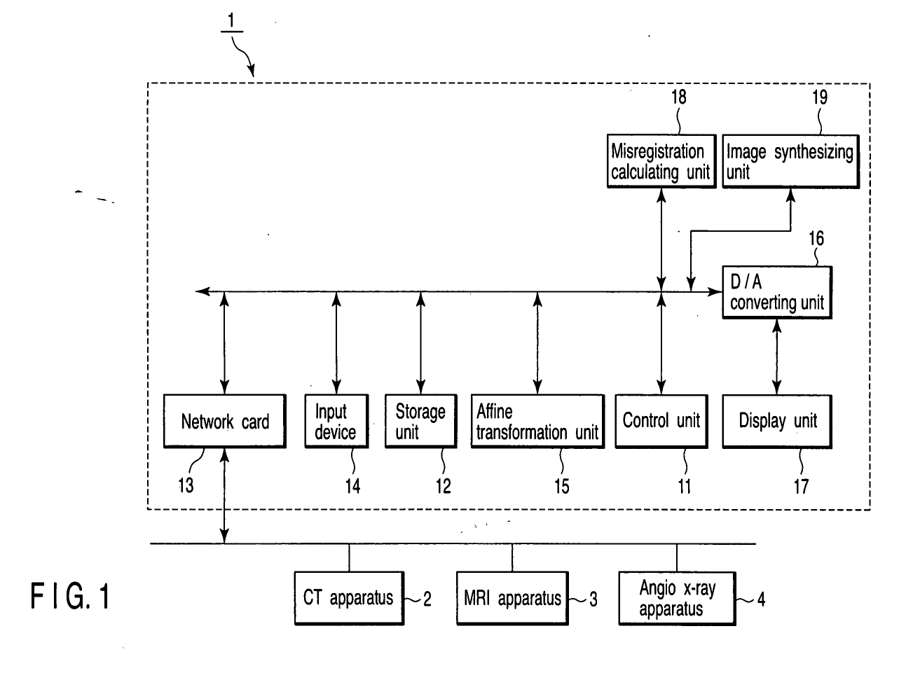

FIG. 1 is a block diagram showing a 3D-image processing apparatus that is a first embodiment of the present invention. As FIG. 1 shows, the 3D-image processing apparatus 1 is connected to a CT apparatus 2, an MRI apparatus 3, and an angio-X-ray apparatus 4.

The 3D-image processing apparatus 1 has a control unit 11, a storage unit 12, a network card 13, an input device 14, an affine transformation unit 15, an A/D (analog-to-digital) converting unit 16, a display unit 17, a displacement-calculating unit 18, and an image-synthesizing unit 19. The control unit 11 comprises a microcomputer. The input device 14 comprises a keyboard and a mouse. Of these components, the network card 13 is connected to the CT apparatus 2, the MRI apparatus 3 and the angio-X-ray apparatus 4, and display unit 17 are connected to the A/D converting unit 16.

When instructed by the control unit 11, the storage unit 12 stores various data items, such as image data, synthesized image data, and the like inputted through the network card 13. The affine transformation unit 15 performs a magnification process and a movement process on the image data.

The displacement-calculating unit 18 reads CT image data generated by the CT apparatus 2 and stored in the storage unit 12. It reads MRI data generated by the MRI apparatus 3. It reads the mask 3D-image data and 3D-DSA image data generated by the angio-X-ray apparatus 4, too. The unit 18 detects displacement between the CT image data and the mask 3D-image data, and displacement between the mask 3D-image data and the 3D-DSA image data, and displacement between the 3D-DSA (Digital Subtraction Angiography) image data and the MRI data. The unit 18 then finds displacement between the CT image data and the MRI data, from the information representing the displacement.

The image-synthesizing unit 19 synthesizes 3D images of two or more types, on the basis of the displacement information provided by the displacement-calculating unit 18.

How the 3D-image processing apparatus 1 thus configured operates will be described.

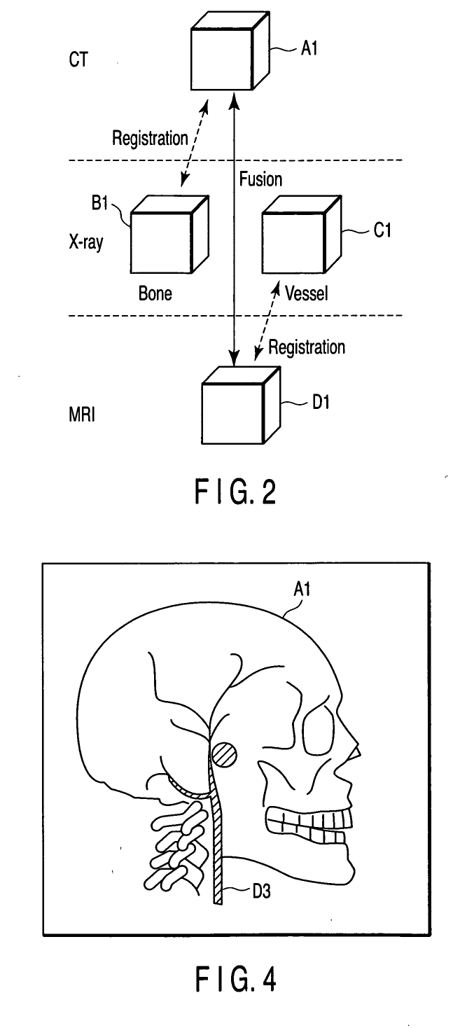

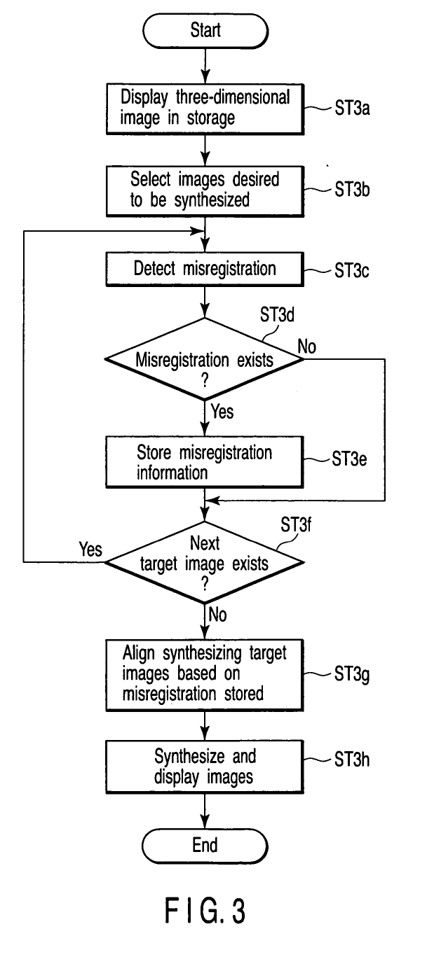

FIG. 2 is a diagram explaining how various images are processed to synthesize CT image data with MRI image data. FIG. 3 is a flowchart explaining a procedure of controlling the 3D-image processing apparatus, i.e., the first embodiment, to synthesize the CT image data with the MRI image.

The CT apparatus 2 collects and reconstructs the 3D-CT images of an arbitrary region in a subject. These reconstructed 3D-CT image data is transmitted to the 3D-image processing apparatus 1. In the apparatus 1, the data is stored in the storage unit 12.

The angio-X-ray apparatus 4 is rotated around the subject, photographing the region in the subject, from various directions, before and after the injection of the contrast medium. A mask 3D image is reconstructed from the images provided before the injection of the contrast medium. The angio-X-ray apparatus 4 subtracting each image provided before the injection from the corresponding image provided after the injection, by scanning the region in the subject from the same direction. Thus, the apparatus 4 prepares a rotated DSA image. The angio-X-ray apparatus 4 reconstructs a 3D-DSA image from the rotated DSA images thus prepared. Two 3D-image data items are transmitted to the 3D-image processing apparatus 1 and stored in the storage unit 12.

The 3D-image processing apparatus 1 starts the control shown in FIG. 3. In Step ST3a, the display unit 17 displays the 3D-CT image (image A1), mask 3D image (image B1), 3D-DSA image (image C1) and MRI (image D1), all stored in the storage unit 12. The user (operator) may operate the input device 14, thus selecting an [Indirect Fusion] button. Images A1 and D1, which are fusion target images, are thereby selected. Further, the user sets registration of B1 and A1, registration of B1 and C1, and registration of C1 and D1 (thus, drawing a relationship line on GUI). Then, the 3D-image processing apparatus 1 proceeds from Step ST3b to Step ST3c. In Step ST3c, the apparatus 1 calculates the displacement. More specifically, the apparatus 1 performs a threshold process, extracting only an image of the bone only B1 and A1. The apparatus 1 then performs cross-correlation on bone images B2 and A2, finding a displacement vector that has a minimum value. Assume that the shifts of (x1, y1, and z1) and the rotations of (Δθx1, Δθy1, and Δθz1) are required to align B2 to the position of the A1. Then, the 3D-image processing apparatus 1 goes from Step ST3d to Step ST3e. In Step ST3e, the storage unit 12 stores the displacement information. Note that Δθx1, Δθy1, and Δθz1 are rotations around axes x, y and z, respectively.

Next, the 3D-image processing apparatus 1 determines whether an image to become a next target exists (Step ST3f). Since C1 exists, the 3D-image processing apparatus 1 goes to Step ST3c. In Step ST3c, it calculates the displacement between B1 and C1. Since B1 and C1 have been reconstructed from the same rotated DSA image, no displacement exists between B1 and C1. Steps ST3c and ST3e are therefore automatically skipped. (Information on the imaging apparatus used, the imaging time and the like are totally identical for each image).

The 3D-image processing apparatus 1 goes from Step ST3f to Step ST3c. In Step ST3c, the apparatus 1 calculates the displacement between image C1 and image D1. More precisely, it performs a threshold process, extracting only an image of the blood vessels from the image D1. Then, the apparatus 1 performs cross correlation on the 3D-DSA image C1 and the blood vessel image D2, finding a displacement vector of a minimum value. Assume that the shifts of (x2, y2, and z2) and the rotations of (Δθx2, Δθy2, and Δθz2) are required to align the image D1 with the image C1. Then, the 3D-image processing apparatus 1 goes from Step ST3d to Step ST3e. In Step ST3e, the storage unit 12 stores the displacement information. Note that Δθx2, Δθy2, and Δθz2 are rotations around the axes x, y and z, respectively.

The 3D-image processing apparatus 1 then proceeds from Step ST3f to Step ST3g. In Step ST3g, the affine transformation unit 15 corrects the displacement. To be more specific, displacement information about the images C1 and D1 is acquired from the storage unit 12. Shifts (x2, y2, and z2) and rotations (Δθx2, Δθy2, and Δθz2) are performed on the image D1, thus providing an image D2′.

Next, the 3D-image processing apparatus 1 corrects the displacement between the images C1 and B1. In this case, the displacement information about the images C1 and B1 should be acquired from the storage unit 12. The storage unit 12 holds no displace information about the image C1 or the image B1. This means that no displacement exists between the images C1 and B1. Hence, no displacement correction is performed.

Further, the 3D-image processing apparatus 1 corrects the displacement between the images B1 and A1. More precisely, the displace information about the images B1 and A1 is acquired from the storage unit 12. Shifts (x1, y1, and z1) and the rotations (Δθx1, Δθy1, and Δθz1) are performed on the images B1 and A1, thereby generating an image D3.

Thereafter, the 3D-image processing apparatus 1 synthesizes the image A1 and the image D3 in a three-dimensional space. The display unit 17 displays such a synthesized image as shown in FIG. 4 (Step ST3h). The synthesized image displayed by the display unit 17 is a combination of, for example, image A1 of the skull and image D3 of the blood vessels.

Shadow information representing CT images of the bones, organs, tumors, etc. can thereby be synthesized with MRI functional information, providing a synthesized image. The synthesized image is displayed. The image is useful for the doctor who makes surgery planning before performing a surgical operation.

In the first embodiment described above, the 3D image processing apparatus 1 uses the mask 3D image data and the 3D-DSA image data to find the displacement between the 3D-CT image data and the MRI data, before synthesizing the 3D-CT image data with the MRI data. The apparatus 1 then synthesizes the CT image data with the MRI data in the 3D space, on the basis of the displacement thus found.

Hence, the 3D-CT image data can be automatically synthesized with the MRI data in accordance with the displacement information, requiring no manpower. Accurate diagnosis can therefore be made easily and reliably in a short time.

Since the display unit 17 displays a 3D synthesized image regarding the subject, doctors can understand various diagnostic results from the synthesized image. This helps them to make a surgery planning before they perform surgical operations.

(Second Embodiment)

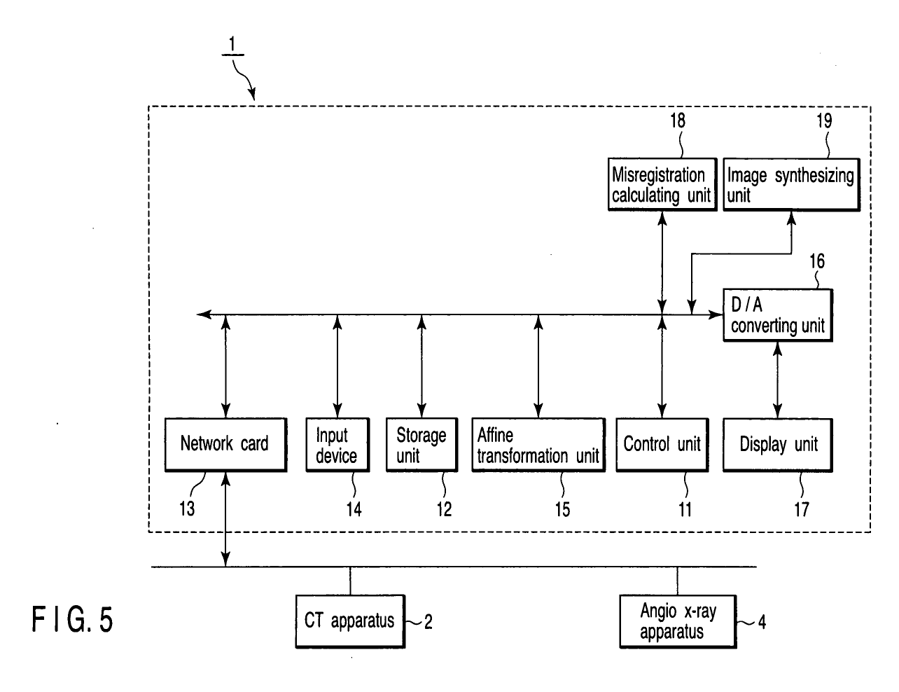

FIG. 5 is a block diagram showing a 3D-image processing apparatus that is a second embodiment of the present invention. As FIG. 5 shows, the 3D-image processing apparatus 1 is connected to a CT apparatus 2 and an angio-X-ray apparatus 4. The components shown in FIG. 5 and identical to those shown in FIG. 1 are designated at the same reference numbers. These components will not be described in detail.

In the 3D-image processing apparatus 1, the display unit 17 displays a 3D-CT image (A1), a mask 3D image (B1), and a 3D-DSA image (C1) stored in a storage unit 12. The user (operator) may push an [Indirect Fusion] button provided on the input device 14, selecting the images A1 and C1. Further, the user sets registration of the images B1 and A1 and registration of the images B1 and C1 (thus, drawing a relationship line on GUI). Then, the 3D-image processing apparatus 1 calculates the displacement between the images B1 and A1. More specifically, it performs a threshold process, extracting only images of the bones from the images B1 and A1. Then, it performs cross-correlation on a bone image B2 and a bone image A1, finding a displacement vector of a minimum value. Assume that shifts (x1, y1, and z1) and rotations of (Δθx1, Δθy1, and Δθz1) should be performed to align the image B1 with the image A1. Then, the storage unit 12 stores the displacement information.

Next, the 3D-image processing apparatus 1 calculates the displacement between the images C1 and B1. Since the image B1 and the image C1 are reconstructed from the same rotated DSA image, no displacement exists. Thus, the processing is automatically skipped. (They are totally identical in terms of imaging apparatus used, the imaging time, and the like).

Then, 3D-image processing apparatus 1 correct the displacement between the image C1 and the image B1. The displacement information about the images C1 and B1 must therefore be acquired from the storage unit 12. Sine the storage unit 12 stores no displacement information about the images C1 and B1, the processing is automatically skipped.

The 3D-image processing apparatus 1 then corrects the displacement between the images B1 and A1. More specifically, the displacement information about the images C1 and B1 is acquired from the storage unit 12. The apparatus 1 then performs shifting (x1, y1, and z1) and rotating (Δθx1, Δθy1, and Δθz1), on the image C1, generating an image C2.

Thereafter, the 3D-image processing apparatus 1 synthesizes the image A1 with the image C2 in a three-dimensional space, providing a synthesized image. The display unit 17 displays the synthesized image.

In the second embodiment described above, too, the CT shade information on the bones, internal organs, tumors, etc. and the detailed 3D angio information on the blood vessels can be synthesized, generating a synthesized image. The synthesized image is displayed. The image helps doctors to understand the relation the blood vessels have with the bones, organs and tumors.

Further, the second embodiment may be modified such that a threshold-value process is performed, extracting a bone portion. The bone part and blood-vessel part may be extracted from the image B1, soft tissues are extracted from the image A1, and the blood vessels are extracted from the image C1.

(Third Embodiment)

A third embodiment of the present invention is applied to computed-tomography angiography (CTA) that is a technique of injecting contrast medium into the veins by using the above-described CT apparatus 2. The third embodiment will be described with reference to FIG. 5.

The CT apparatus 2 collects 3D-CTA images of the arteries and veins, at an arbitrary region in the subject. The apparatus 2 reconstructs the images, generating 3D-CTA image data. The 3D-CTA image data is transmitted to a 3D-image processing apparatus 1 and stored in a storage unit 12.

That is, in the 3D-image processing apparatus 1, the display unit 17 displays a 3D-CTA image (A1), a mask 3D image (B1) and a 3D-DSA image (C1), all stored in the storage unit 12. In this state, the user (operator) may push an [Indirect Fusion] button provided on the input device 14, selecting the images A1 and C1 that are fusion target images. The user may further set the registration of the image B1 with the image A1 and the registration of the image B1 with the image C1 (drawing a line of relationship on GUI). The apparatus 1 then calculates the displacement between the image B1 and the image A1. More specifically, the apparatus 1 extracts only the bone by performing a threshold process on the image B1 and the image A1. The apparatus 1 also performs cross-correlation calculation by a bone image A2 and a bone image B2 obtained by the threshold value processing to find displacement vector in which that calculation value becomes the minimum. To align the image B1 with the image A1 in position, the shifts (x1, y1, and z1) and the rotations of (Δθx1, Δθy1, and Δθz1) are required. In the 3D image processing apparatus 1, the storage unit 12 stores the displacement information.

Next, the 3D image processing apparatus 1 calculates the displacement between the image B1 and the image C1. The images B1 and C1 have been reconstructed from the same rotation DSA image, they are not displaced from each other. The process of calculating the displacement is automatically skipped. (These images are totally identical in terms of the imaging apparatus used, the imaging time, and the like.) Since the storage unit 12 stores no displacement information about the images C1 and B1, the process is automatically skipped.

Further, the 3D image processing apparatus 1 corrects the displacement between the images B1 and A1. More precisely, displacement data about the images B1 and A1 is acquired from the storage unit 12. Then, the apparatus 1 performs shifts (x1, y1, and z1) and rotations (Δθx1, Δθy1, and Δθz1), generating an image C2.

Thereafter, the 3D image processing apparatus 1 synthesizes the image A1 and the image C2 in a three-dimensional space, providing a synthesized image. The display unit 17 displays the synthesized image. At this time, in the blood vessels of CTA and 3D-DSA overlap at some parts and do not overlap at the other parts. CTA shows the images of all arteries and the images of all veins. But, 3D-DSA shows the images of the veins only. Therefore, the arteries overlapping are displayed in one color, and the arteries not overlapping are display in another color.

Thus, the positional relationship between the arteries and the veins can be clearly presented in the third embodiment described above.

(Fourth Embodiment)

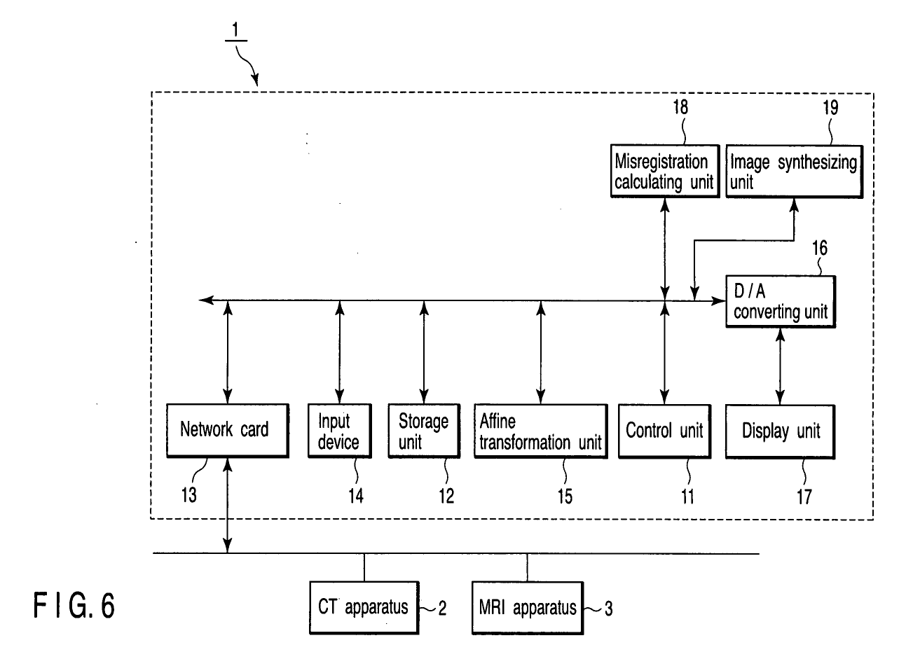

FIG. 6 is a block diagram showing a fourth embodiment of the 3D image processing apparatus of the present invention. As FIG. 6 shows, this 3D image processing apparatus 1 is connected to a CT apparatus 2 and an MRI apparatus 3. The components shown in FIG. 6 and identical to those shown in FIG. 1 are designated at the same reference numbers in FIG. 6, and will not be described in detail.

The CT apparatus 2 collects and reconstructs the 3D-CT images of an arbitrary region in a subject, generating 3D-CT image data. The 3D-CT image data is transmitted to the 3D image processing apparatus 1. In the apparatus 1, the data is stored in the storage unit 12.

The MRI apparatus 3 collects and reconstructs two types of 3D MRI images of an arbitrary region in the subject. One reconstructed MRI image is an image (e.g., TI weighted image) from which the anatomical data can easily be obtained. The other reconstructed MRI image is an image that has functional diagnostic data. (The other reconstructed MRI image is a T2-weighted image from which legion can be easily detected or a DWI, functional MRI or perfusion MRI image that presents functional diagnostic data.) The 3D MRI image data generated by the MRI apparatus 3 is transmitted to the 3D image processing apparatus 1. In the apparatus 1, the MRI image data is stored in the storage unit 12.

The 3D image processing apparatus 1 starts a control shown in FIG. 3. In Step ST3a, the display 17 displays the 3D-CT image (image A1), the MRI image (image B1) presenting anatomical data and an MRI image (image C1) presenting functional data, all stored in the storage unit 12. The user (operator) may operates the [Indirect Fusion] button provided on an input device 14, selecting the images A1 and C1 being fusion target images, and may further set the registration of the image B1 with the image A1 and the registration of the image B1 with the image C1 (drawing a line of relationship on GUI). The apparatus 1 then goes from Step ST3b to Step ST3c. In Step ST3c, the apparatus 1 finds the displacement between B and A1. More specifically, an image of the brain is extracted from B1 and A1, and cross-correlation calculation is performed on B2 and A2, and a displacement vector is obtained, in which that value found in the cross-correlation calculation is minimal. Assume that shifts (x1, y1, and z1) and rotations (Δθx1, Δθy1, and Δθz1) should be performed to align images B2 and A2. In this case, the 3D image processing apparatus 1 goes from Step ST3d to Step ST3e. In Step ST3e, the storage unit 12 stores the displacement information. Note that Δθx2, Δθy2, and Δθz2 are rotations around the axes x, y and z, respectively.

It is more difficult to extract an image of the brain than to extract an image of the skull. The process of extracting the imager of the brain will be briefly explained. First, a process called “bone removal” is performed. The bone removal is a technique well known in the field of CT technology. The position of the bone to be removed identified with a CT value, and the image of the bone and the image of the soft tissue surrounding the bone are extracted. Second, the image of the skull is cut at the base by manual operation, and the image of the brain is extracted. To extract the image of the brain from the image B1, the image of the skull is cut at the base, the brain is designated, and only the image of the brain (including the hard membrane) is extracted by the region-growing method. The 3D images thus extracted are subjected to high-frequency filtering. The result of the filtering is multiplied by a probability functional determined by a voxel value. Images B2 and A2 are thereby formed. Image A2 is obtained as follows.
A₂(x,y,z)={Aₑ(x,y,z)*H(x,y,z)}×p{Aₑ(x,y,z)
where A₂(x,y,z) is data acquired by extracting the brain image by manual operation, H(x,y,z) is the high-frequency filter, * is a convolution operator, and P( ) is the probability functional. The probability functional represents the probability that a given CT value represents the brain. The probability functional is 0 if the CT value is −1000 or 1000, is 1 if the CT value is 10 to 20, or at the brain level, and is close to 1 if the CT value is a little smaller than 10 or a little greater than 20. The smaller the functional is than 10, or the greater the functional is than 20, the more rapidly the functional approaches 0.

Next, the 3D-image processing apparatus 1 determines whether any image to be processed exists or not (Step ST3f). Since images C1 and B1 exist, the apparatus 1 proceeds to Step ST3c. In Step ST3c, the displacement between C1 and B1 is calculated. The images C1 and B1 have been collected and reconstructed by the same apparatus, i.e., MRI apparatus 3. Therefore, C1 and B1 are not displaced from each other (that is, they are identical in terms of the imaging apparatus, the imaging time and the like). Hence, Step ST3c is skipped.

Then, the 3D-image processing apparatus 1 corrects the displacement between the images CI and B1. That is, the displacement information about the images C1 and B1 is acquired from the storage unit 12. Since the unit 12 stores no displacement information about these images, the images C1 and B1 are considered not displaced at all. The displacement correction is therefore skipped.

The 3D-image processing apparatus 1 then corrects the displacement between the 3D images B1 and A1. That is, the displacement information about the images B1 and A1 is acquired from the storage unit 12. Then, shifts (x1, y1, and z1) and rotations (Δθx1, Δθy1, and Δθz1) are performed first on the image C1, generating image C2.

Thereafter, the 3D-image processing apparatus 1 synthesizes the images A1 and C2 in a three-dimensional space, providing a synthesized image. The display unit 17 displays the synthesized image. The images A1 and C2 may be synthesized, first by displaying the CT image and the MRI image in gray scale and color, respectively, and then by combining these images, thereby forming a 3D image or a tomogram. Alternatively, they may not be combined directly. Instead, they may be first displayed these two images side by side. As one tomogram is moved, the other tomogram is moved, too. Further, as a specific position in one tomogram is pointed, the corresponding position in the other tomogram is pointed, too. Thus, doctors can make a diagnosis from the CT structural information about bones, organs, tumors, etc., which is associated with the MRI functional information. This helps them to make a surgery planning before they perform surgical operations.

(Fifth Embodiment)

A fifth embodiment of the present invention will be described with reference FIG. 6, too.

The CT apparatus 2 collects and reconstructs 3D-CAT images of an arbitrary region in a subject the A, generating 3D-image data, while a contrast medium is being injected into the veins. The 3D image data is transmitted to the 3D-image processing apparatus 1. In the apparatus 1, the storage unit 12 stores the 3D image data.

The MRI apparatus 3 collects and reconstructs two types of 3D MRI images of an arbitrary region in the subject. One reconstructed MRI image is an image in which the blood vessels are weighted. The other reconstructed MRI image is an image that has functional diagnostic data. (The other reconstructed MRI image is a T2-weighted image from which legion can be easily detected or a DWI, functional MRI or perfusion MRI image that presents functional diagnostic data.) The 3D MRI image data generated by the MRI apparatus 3 is transmitted to the 3D image processing apparatus 1. In the apparatus 1, the MRI image data is stored in the storage unit 12.

The 3D image processing apparatus 1 starts a control shown in FIG. 3. In Step ST3a, the display 17 displays the 3D-CT image (image A1), the MRI image (image B1) presenting anatomical data and an MRI image (image C1) presenting functional data, all stored in the storage unit 12. The user (operator) may operates the [Indirect Fusion] button provided on an input device 14, selecting the images A1 and C1 being fusion target images, and may further set the registration of the image B1 with the image A1 and the registration of the image B1 with the image C1 (drawing a line of relationship on GUI). The apparatus 1 then goes from Step ST3b to Step ST3c. In Step ST3c, the apparatus 1 finds the displacement between B1 and A1. More specifically, an image of the brain is extracted from B1 and A1, and cross-correlation calculation is performed on B2 and A2, and a displacement vector is obtained, in which that value found in the cross-correlation calculation is minimal. Assume that shifts (x1, y1, and z1) and rotations (Δθx1, Δθy1, and Δθz1) should be performed to align images B2 and A2. Then, the 3D image processing apparatus 1 goes from Step ST3d to Step ST3e. In Step ST3e, the storage unit 12 stores the displacement information. Note that Δθx2, Δθy2, and Δθz2 are the rotations around the axes x, y and z, respectively.

Next, the 3D-image processing apparatus 1 determines whether any image to be processed exists or not (Step ST3f). Since images C1 and B1 exist, the apparatus 1 proceeds to Step ST3c. In Step ST3c, the displacement between C1 and B1 is calculated. The images C1 and B1 have been collected and reconstructed by the same apparatus, i.e., MRI apparatus 3. Therefore, C1 and B1 are not displaced from each other (that is, they are identical in terms of the imaging apparatus used, the inspection ID, and the like).

Then, the 3D-image processing apparatus 1 corrects the displacement between the images CI and B1. More precisely, the displacement information about the images C1 and B1 is acquired from the storage unit 12. Since the unit 12 stores no displacement information about these images, the images C1 and B1 are considered not displaced at all. The displacement correction is therefore skipped.

The 3D-image processing apparatus 1 then corrects the displacement between the 3D images B1 and A1. That is, the displacement information about the images B1 and A1 is acquired from the storage unit 12. Then, shifts (x1, y1, and z1) and rotations (Δθx1, Δθy1, and Δθz1) are performed first on the image C1, generating image C2.

Thereafter, the 3D-image processing apparatus 1 synthesizes the images A1 and C2 in a three-dimensional space, providing a synthesized image. The display unit 17 displays the synthesized image. The images A1 and C2 may be synthesized, first by displaying the CT image and the MRI image in gray scale and color, respectively, and then by combining these images, thereby forming a 3D image or a tomogram. Alternatively, they may not be combined directly. Instead, they may be first displayed these two images side by side. As one tomogram is moved, the other tomogram is moved, too. Further, as a specific position in one tomogram is pointed, the corresponding position in the other tomogram is pointed, too. Thus, doctors can make a diagnosis from the CT structural information about bones, organs, tumors, etc., which is associated with the MRI functional information. This helps them to make a surgery planning before they perform surgical operations.

(Sixth Embodiment)

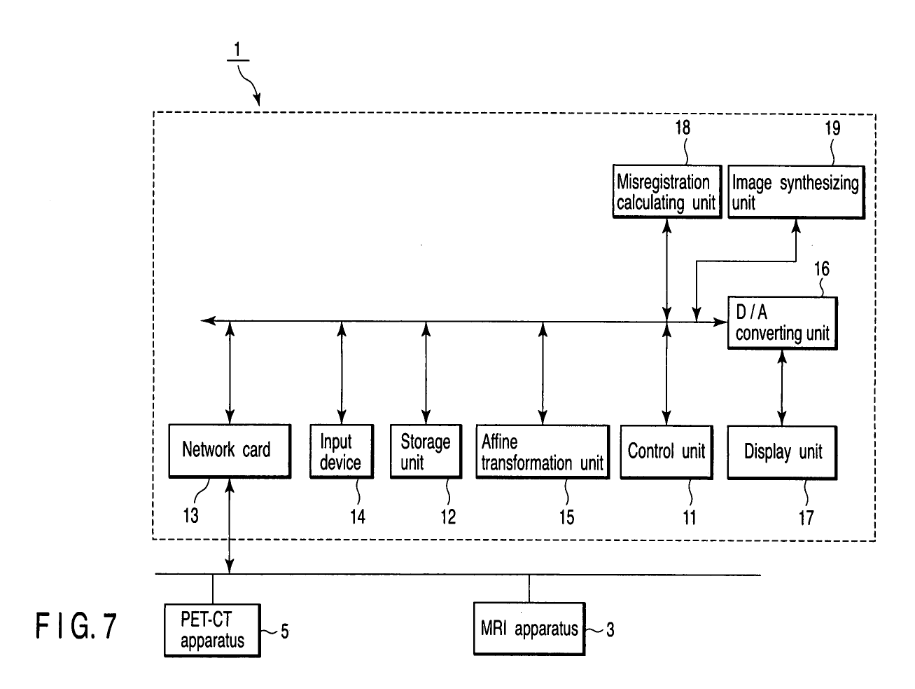

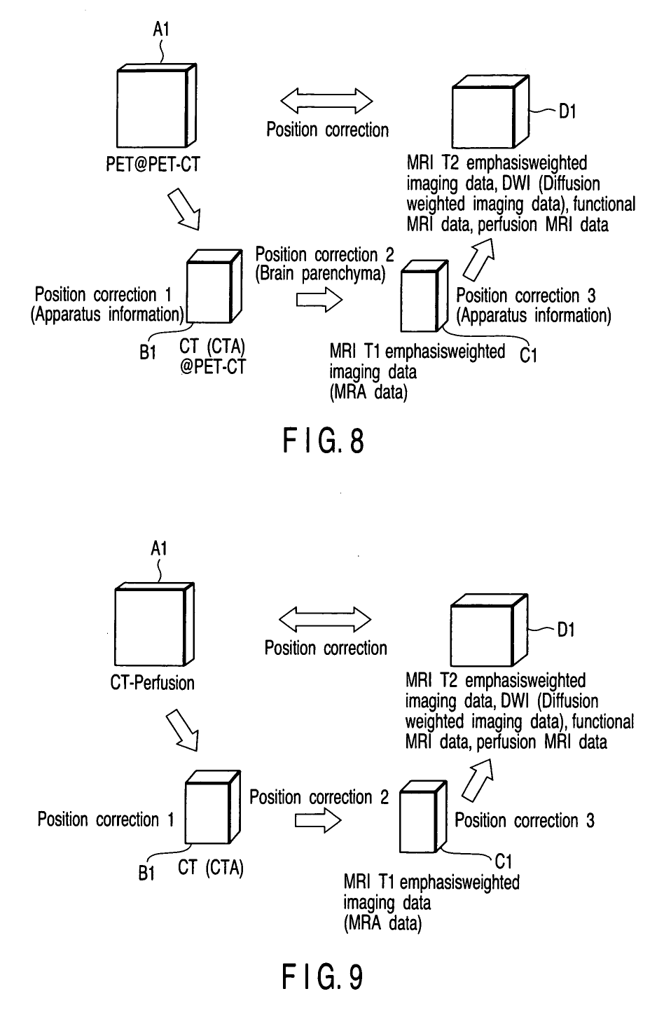

FIG. 7 is a block diagram showing a sixth embodiment of the 3D-image processing apparatus of the present invention. An MIR apparatus 3 and a position emission tomography (PET)-CT apparatus 5 are connected to the 3D-image according to this embodiment. The components identical to those shown in FIG. 1 are designated at the same reference numbers in FIG. 7, and will not be described in detail.

The PET-CT apparatus 5 superposes functional image information obtained by PET inspection conducting a diagnosis of malignant tumors on morphological information. The 3D PET image data obtained by this PET-CT apparatus 5 and the CTA image data photographed and reconstructed while a contrast medium is being injected into the veins are transmitted to the 3D-image processing apparatus 1 and stored in a storage unit 12 provided in the apparatus 1.

Further, the MRI apparatus 3 collects and reconstructs the 3D magnetic resonance angiography (MRA) image of an arbitrary region in the subject regarding the arteries and veins. The reconstructed 3D MRA (MR angiography) image data and the 3D MRI data are transmitted to the 3D-image processing apparatus 1 and stored in the storage unit 12.

That is, in the 3D-image processing apparatus 1C of FIG. 7, the display unit 17 displays a 3D PET image (A1), a 3D-CTA image (B1), a 3D-MRA image (C1), and a functional image (e.g., blood-flow (Perfusion) MRI image (D1), all stored in the storage unit 12. In this state, the user (operator) may operate an [Indirect Fusion] button provided on the input device 14, selecting the image A1 and the image D1, both being Fusion target images. The operator may further set registration of the images A1 and the image B1, registration of the image B1 and the image C1, and registration with the C1 and the D1 (draws a line of relationship on GUI). Then, the 3D-image processing apparatus 1 calculates the displacement between the image A1 and the image B1. In this case, the images A1 and B1 have been collected and reconstructed by the same apparatus, i.e., PET-CT apparatus. Hence, they are not displaced from each other. The process of calculating the displacement is automatically skipped. (This is because, the images are identical in terms of the imaging apparatus used, the inspection ID, and the like.)

Next, the 3D-image processing apparatus 1 finds the displacement between the image B1 and the image C1. More specifically, the apparatus 1 extracts the images of blood vessels from the images B1 and C1, and performs the cross-correlation calculation on the image B1 and C1, finding a displacement vector of the minimum value. The displacement information is in the storage unit 12.

Subsequently, the 3D-image processing apparatus 1 calculates the displacement between the image C1 and the image D1. In this case, the images C1 and D1 have been collected and reconstructed by the same apparatus, i.e., MRI apparatus 2, and are not displaced from each other. The process of calculating the displacement is therefore automatically skipped. (That is, the images are identical in terms of the imaging apparatus used, the inspection ID, and the like.).

Next, the 3D-image processing apparatus 1 corrects the displacement between the image D1 and the image C1. To be more specific, the displacement information about the images D1 and C1 is acquired from the storage unit 12. Since there is no displacement information about these images, it is determined that no displacement exists. Hence, the process of correcting the displacement is skipped.

The 3D-image processing apparatus 1 then collects the displacement between the image C1 and the image B1. More precisely, the displacement information about the images C1 and B1 is acquired from the storage unit 12. Using the displacement information, the apparatus 1 correct the displacement of the image D1, thereby generating an image D2.

Further, the 3D-image processing apparatus 1 corrects the displacement between the image B1 and the image A1. That is, the displacement information about the images B1 and A1 is acquired from the storage unit 12. Since there is no displacement information about these images, it is determined that these images are not displaced. Hence, the process of correcting displacement is skipped.

After that, based on total pieces of displacement information stored in the storage unit 12, the 3D-image processing apparatus 1 synthesizes the image A1 with the image D2, and, if necessary, with the image B1, in a three-dimensional space. The display unit 17 displays the resulting synthesized image.

In the sixth embodiment described above, the 3D-image processing apparatus 1 finds the displacement between a 3D-PET-CD image data and the functional data on the basis of the 3D-CTA image data and the 3D-MRA image data, before synthesizing the 3D-PET-CD image data and the functional data. Based on the displacement information, the apparatus 1 synthesizes the 3D-CTA image data and the 3D-MRA image data. (The functional data is, for example, T2-weighted image (MRI T2 weighted imaging data) from which legion can be easily detected, or a DWI (diffusion-weighted imaging data), functional MRI or perfusion MRI image that presents functional diagnostic data.)

In this embodiment, the image B1 is a 3D-CTA image, and the image C1 is a 3D-MRA image. Instead, the image B1 may be a 3D-CT image, and the image C1 may be an image from which anatomical information can easily acquired (e.g., an MRI TI weighted imaging data).

Hence, the diagnostic information on the malignant tumors and the like obtained by the PET-CT apparatus 5 and the blood-flow information by MRI can be synthesized, and a resulting synthesized image can be displayed. This is useful, for example, for forming a plan when performing the surgical operation.

(Seventh Embodiment)

A seventh embodiment of the present invention is configured to synthesize and process blood-flow CT image data and blood-flow MRI data by using the above-described CT apparatus 2.

That is, In the 3D-image processing apparatus 1 shown in FIG. 9, the display unit 17 displays a 3D blood-flow CT image (A1), a 3D CTA image (B1), a 3D-MRA image (C1), and functional data (D1), stored in the storage unit 12.

In this state, the user (operator) may push the [Indirect Fusion] button provided on the input device 14, selecting the images A1 and D1, i.e., Fusion target images, and further setting registration of the images B1 and C1 and registration of the images C1 and d1 (drawing a line of relationship on GUI). Then, the 3D-image processing apparatus 1 calculate the displacement between the image A1 and the image B1. Since the images A1 and B1 have been collected and reconstructed by the same apparatus, i.e., CT apparatus 2, they are not displaced from each other (they are totally identical in terms of the imaging apparatus used, the inspection ID, and the like).

Next, the 3D-image processing apparatus 1 calculates the displacement between the image B1 and the image C1. More specifically, the apparatus 1 extracts images of the blood vessels from the image B1 and C1 and performs cross-correlation on the blood-vessel images, finding a displacement vector of the minimum value. The displacement information is in the storage unit 12.

Subsequently, the 3D-image processing apparatus 1 calculates the displacement between the image C1 and the image D1. In this case, the images C1 and D1 have been collected and reconstructed by the same apparatus, i.e., MRI apparatus 2, and are not displaced from each other. The process of calculating the displacement is therefore automatically skipped. (That is, the images are identical in terms of the imaging apparatus used, the inspection ID, and the like.).

Next, the 3D-image processing apparatus 1 corrects the displacement between the image D1 and the image C1. To be more specific, the displacement information about the images D1 and C1 is acquired from the storage unit 12. Since there is no displacement information about these images, it is determined that no displacement exists. Hence, the process of correcting the displacement is skipped.

The 3D-image processing apparatus 1 then collects the displacement between the image C1 and the image B1. More precisely, the displacement information about the images C1 and B1 is acquired from the storage unit 12. Using the displacement information, the apparatus 1 correct the displacement of the image D1, thereby generating an image D2.

Further, the 3D-image processing apparatus 1 corrects the displacement between the image B1 and the image A1. That is, the displacement information about the images B1 and A1 is acquired from the storage unit 12. Since there is no displacement information about these images, it is determined that these images are not displaced. Hence, the process of correcting displacement is skipped.

Thereafter, the 3D-image processing apparatus 1 synthesizes the image A1 with the image D2 and, if necessary, with the image B1, in a three-dimensional space, on the basis of total pieces of displacement information stored in the storage unit 12. The display unit 17 displays the resulting synthesized image.

In the seventh embodiment described above, the 3D-image processing apparatus 1 uses the 3D-CTA image data and the 3D-MRA image data, finding the displacement between the 3D-CT blood-flow image data and the 3D-MRA blood-flow image data, before synthesizing the 3D blood-flow CT image data and the functional data. The apparatus 1 synthesizes images in a three-dimensional space, on the basis of the information representing the displacement thus found.

In this embodiment, the image B1 is a 3D-CTA image, and the image C1 is a 3D-MRA image. Instead, the image B1 may be a 3D-CT image, and the image C1 may be an image from which anatomical information can easily acquired (e.g., an MRI TI weighted image).

Thus, the blood-flow information by CT and the blood-flow information by MRI can be synthesized, and a resulting synthesized image can be displayed. This is useful, for example, for forming a plan when performing the surgical operation.

(Other Embodiments)

Various embodiments of the present invention have been described. Nevertheless, the present invention is not limited to the embodiments described above. The components of any embodiment can be modified in various manners in reducing the invention to practice, without departing from the sprit or scope of the invention. Further, the components of the embodiments described above may be combined, if necessary, to make different inventions. For example, some of the component of any embodiment may not be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A 3D-image processing apparatus comprising:
a first acquisition device which acquires displacement information about first 3D-imaging data and second 3D-imaging data different from the first 3D-imaging data, said first 3D-imaging data representing one of three-dimensional images different in diagnostic mode regarding a subject;
a second acquisition device which acquires displacement information about the second 3D-imaging data and a third 3D-imaging data different from the first and second 3D-imaging data; and
a computing unit which obtains displacement information about the first 3D-imaging data and the third 3D-imaging data, from the displacement information acquired by the first and second acquisition devices.

2. The 3D-image processing apparatus according to claim 1, further comprising a display unit which synthesizes the first 3D-imaging data and the third 3D-imaging data of the displacement information acquired by the computing unit, and which displays a resulting synthesized image.

3. The 3D-image processing apparatus according to claim 2, wherein the first 3D-imaging data represents morphological features of the subject, and the third 3D-imaging data represents functional features of the subject.

4. The 3D-image processing apparatus according to claim 1, which comprises a third acquisition device which acquires displacement information about the third 3D-imaging data and fourth 3D-imaging data different from the first, second and third 3D-imaging data, and in which the computing unit obtains displacement information about the first 3D-imaging data and the fourth 3D-imaging data, from the displacement information acquired by the first, second and third acquisition devices.

5. The 3D-image processing apparatus according to claim 4, further comprising a display unit which synthesizes the first 3D-imaging data and the fourth 3D-imaging data on the basis of the displacement information obtained by the computing unit, and which displays a resulting synthesized image.

6. The 3D-image processing apparatus according to claim 4, wherein the first to fourth 3D-imaging data are 3D-imaging data acquired by at least one of different imaging methods, different reconstruction methods and different apparatuses.

7. The 3D-image processing apparatus according to claim 1, wherein, when the first 3D-imaging data is computed tomography (CT) imaging data and the third 3D-imaging data is magnetic resonance imaging (MRI) data, the computing unit obtains displacement information about the CT imaging data and the MRI data by using contrast 3D-imaging data.

8. The 3D-image processing apparatus according to claim 1, wherein, when the first 3D-imaging data is CT imaging data and the third 3D-imaging data is 3D-DSA imaging data, the computing unit obtains displacement information about the CT imaging data and the 3D-DSA imaging data by using either contrast 3D-imaging data or mask 3D-imaging data.

9. The 3D-image processing apparatus according to claim 1, wherein, when the first 3D-imaging data is CTA (CT Angiography) imaging data and the third 3D-imaging data is 3D-DSA imaging data, the computing unit obtains displacement information about the CTA imaging data and the 3D-DSA imaging data by using either contrast 3D-imaging data or mask 3D-imaging data.

10. The 3D-image processing apparatus according to claim 4, wherein the first 3D-imaging data is CT imaging data, the second 3D-imaging data is mask 3D-imaging data reconstructed from a mask image, the third 3D-imaging data is 3D-DSA imaging data, and the fourth 3D-imaging data is MRI data.

11. The 3D-image processing apparatus according to claim 4, wherein, when the first 3D-imaging data is positron emission tomography (PET)-CT imaging data and the fourth 3D-imaging. data is Perfusion MRI data, diffusion-weighted imaging data or functional MRI data, the computing unit obtains displacement information about the PET-CT imaging data and the Perfusion MRI data, the diffusion-weighted imaging data or the functional MRI data, by using 3D computed tomography angiography (CTA) imaging data and 3D magnetic resonance angiography (MRA) imaging data.

12. The 3D-image processing apparatus according to claim 4, wherein, when the first 3D-imaging data is PET-CT imaging data and the fourth 3D-imaging data is Perfusion MRI data, diffusion-weighted imaging data or functional MRI data, the computing unit obtains displacement information about the PET-CT image data and the Perfusion MRI data, the diffusion-weighted imaging data or the functional MRI data, by using 3D-CT imaging data obtained by PET-CT and 3D-MRI image.

13. The 3D-image processing apparatus according to claim 4, wherein, when the first 3D-image data is Perfusion CT image data and the fourth 3D-imaging data is MRI T2-weighted imaging data, diffusion-weighted imaging data, functional MRI data or Perfusion MRI imaging data, the computing unit obtains displacement information about the PET-CT image data and the MRI T2-weighted imaging data, the diffusion-weighted imaging data or the functional MRI data, by using 3D-CTA imaging data and 3D-MRA imaging data.

14. The 3D-image processing apparatus according to claim 4, wherein, when the first 3D-image data is Perfusion CT image data and the fourth 3D-imaging data is Perfusion MRI data, MRI T2-weighted imaging data, diffusion-weighted imaging data, functional MRI data or Perfusion MRI imaging data, the computing unit obtains displacement information about the Perfusion CT imaging data and Perfusion MRI data, MRI T2-weighted imaging data, the diffusion-weighted imaging data, the functional MRI data or the Perfusion MRI imaging data, by using 3D-CT imaging data and 3D-MRA image.

15. The 3D-image processing apparatus according to claim 1, wherein, when the first 3D-image data is 3D-CT imaging data and the third 3D imaging data is Perfusion MRI data, MRI T2-weighted imaging data, diffusion-weighted imaging data, functional MRI imaging data or Perfusion MRI imaging data, the computing unit obtains displacement information about the 3D-CT imaging data and the Perfusion MRI data, MRI T2-weighted imaging data, diffusion-weighted imaging data, functional MRI imaging data or Perfusion MRI imaging data, by using the 3D-MRI image.

16. The 3D-image processing apparatus according to claim 1, wherein, when the first 3D-image data 3D-CTA imaging data and the third 3D imaging data is Perfusion MRI data, MRI T2-weighted imaging data, diffusion-weighed imaging data, functional MRI imaging data or Perfusion MRI imaging data, the computing unit obtains displacement information about the 3D-CTA imaging data and the Perfusion MRI imaging data, MRI T2-weighted imaging data, diffusion-weighted imaging data, functional MRI imaging data or Perfusion MRI imaging data, by using the 3D MRA image.

17. The 3D-image processing apparatus according to claim 1, wherein the first 3D imaging data and the third 3D imaging data have been obtained by imaging an object and reconstructed in different modalities.

18. The 3D-image processing apparatus according to claim 4, wherein the first 3D imaging data and the third 3D imaging data have been obtained by imaging an object and reconstructed in different modalities.

19. A 3D-image processing method comprising:
acquiring first displacement information representing displacement between first 3D-imaginge data and second 3D-imaging data different from this first 3D-imaging data, said first 3D-imaging data representing one of 3D images different in a diagnostic mode regarding a subject;
acquiring second displacement information representing displacement between the second 3D-image data and third 3D-imaging data different from the first and second 3D-imaging data; and
obtaining third displacement information representing displacement between the first 3D-imaginge data and the third 3D-imaging data, from the first displacement information and the second displacement information.

20. A control program to be recorded in a memory provided in a three-dimensional image processing apparatus, to perform an image processing of three-dimensional image data, the program comprising:
a first step of acquiring first displacement information representing displacement between first three-dimensional image data and second three-dimensional image data different from this first three-dimensional image data, said first three-dimensional image data representing one of three-dimensional images different in a diagnostic mode regarding a subject;
a second step of acquiring second displacement information about the second three-dimensional image data and third three-dimensional image data different from the first and second three-dimensional image data; and
a third step of obtaining displacement information about the first three-dimensional image data and the third three-dimensional image data from on the first displacement information and the second displacement information.
